(19) United States
(12) Patent Application Publication
(10) Pub. No.: US 2022/0244062 A1
(43) Pub. Date: Aug. 4, 2022

(54) METHOD, APPARATUS AND COMPUTER PROGRAM PRODUCT FOR NAVIGATION USING BEHAVIOR AND COGNITIVE MODELS

(71) Applicant: HERE GLOBAL B.V., Eindhoven (NL)

(72) Inventors: Arun BALAKRISHNA, Frankfurt (DE); Tom GROSS, Bamberg (DE)

(21) Appl. No.: 17/646,365

(22) Filed: Dec. 29, 2021

Related U.S. Application Data
(60) Provisional application No. 63/143,096, filed on Jan. 29, 2021.

(51) Int. Cl. G01C 21/34

(52) U.S. Cl. CPC G01C 21/3484; G01C 21/343; G01C 21/3476

(57) ABSTRACT

A method, apparatus, and computer program product are therefore provided for reducing the cognitive cost of a journey to an operator through a reduction in the cognitive cost of guidance information. Methods may include: receiving an indication of a journey to a destination including a plurality of entities of interest (EOIs); identifying a next entity of interest (EOI); determine guidance information relative to the next EOI; determining cognitive cost of the journey up to the next EOI; in response to the cognitive cost of the journey up to the next EOI not satisfying a predetermined value: determining new guidance information relative to the next EOI having a lower cognitive cost; recalculating the cognitive cost of the journey up to the next EOI; and in response to the cognitive cost of the journey up to the next EOI satisfying a predetermined value, providing the guidance information relative to the next EOI.

### CROSS-REFERENCE TO RELATED APPLICATIONS

This application claims priority to U.S. Provisional Patent Application Ser. No. 63/143,096, filed on Jan. 29, 2021, the contents of which are hereby incorporated by reference in their entirety.

### TECHNOLOGICAL FIELD

An example embodiment of the present invention relates generally to determining a cognitive cost to an operator for a journey, and more particularly, to reducing the cognitive cost of a journey to an operator through a reduction in the cognitive cost of guidance information.

### BACKGROUND

Maps have been used for centuries for providing route geometry and geographical information, while routes have conventionally been planned by hand along paths defined by the maps. Conventional paper maps including static images of roadways and geographic features from a snapshot in history have given way to digital maps presented on computers and mobile devices, and navigation has been enhanced through the use of graphical user interfaces.

Digital maps and navigation can provide dynamic route guidance to users as they travel along a route. Further, dynamic map attributes such as route traffic, route conditions, and other dynamic map-related information may be provided to enhance the digital maps and facilitate navigation. Navigation systems provide information to a user such as current location of the user within the map and provides both audio and visual information for guidance when traveling from one location to another. Visual displays of route guidance instructions may not always be convenient or safe for a user to reference. As such, route guidance is often coupled with audible commands regarding maneuvers such as turns. However, these audible commands combined with the available visual instructions on a display may overwhelm a vehicle operator and may lead to confusion.

### BRIEF SUMMARY

Example embodiments therefore provided for determining a cognitive cost to an operator for a journey, and more particularly, to reducing the cognitive cost of a journey to an operator through a reduction in the cognitive cost of guidance information. Embodiments provide an apparatus including at least one processor and at least one non-transitory memory including computer program code instructions, the computer program code instructions may be configured to, when executed, cause the apparatus to at least: receive an indication of a journey from an origin to a destination, where the journey includes a plurality of entities of interest (EOIs) along the journey; identify a set of next EOIs of the plurality of EOIs; determine guidance information relative to the set of next EOIs; determine cognitive cost of the journey up to the set of next EOIs; in response to the cognitive cost of the journey up to the set of next EOIs not satisfying a predetermined value: determine new guidance information relative to the set of next EOIs having a lower cognitive cost; recalculate the cognitive cost of the journey up to the set of next EOIs with the new guidance information relative to the set of next EOIs; and in response to the cognitive cost of the journey up to the set of next EOIs satisfying the predetermined value, provide the guidance information relative to the set of next EOIs to an operator.

According to some embodiments, causing the apparatus to identify the set of next EOIs of the plurality of EOIs includes causing the apparatus to obtain a cognitive load for the set of next EOIs based on historical behavior models and obtain a current cognitive state of the operator. Causing the apparatus of some embodiments to determine cognitive cost of the journey up to the set of next EOIs includes causing the apparatus to determine the cognitive cost of the journey up to the set of next EOIs by inputting to a cognitive model the cognitive load for the set of next EOIs, the current cognitive state of the operator, and the guidance information. Causing the apparatus of certain embodiments to determine guidance information relative to the set of next EOIs includes causing the apparatus to: identify gaps in understanding of information or maneuvers relative to the set of next EOIs; and generate guidance information to fill identified gaps in understanding.

According to some embodiments, causing the apparatus to determine new guidance information relative to the set of next EOIs having a lower cognitive cost includes causing the apparatus to determine the guidance information relative to the set of next EOIs having a lower cognitive cost using operator context, a behavior model, and a cognitive model. Causing the apparatus of certain embodiments to determine cognitive cost of the journey up to the set of next EOIs includes causing the apparatus to determine a cognitive cost for each of the plurality of EOIs up to and including the set of next EOIs, where the cognitive cost for each of the plurality of EOIs is determined based on a cognitive state of a respective EOI, a duration of the cognitive state of the respective EOI, and a weight afforded to the respective EOI. The cognitive cost for each of the plurality of EOIs is further determined, in some embodiments, based on a cognitive state transition from a previous cognitive state to the cognitive state of the respective EOI and map information associated with the respective EOI.

Embodiments provided herein include a computer program product including at least one non-transitory computer-readable storage medium having computer-executable program code instructions stored therein, the computer-executable program code instructions including program code instructions to: receive an indication of a journey from an origin to a destination, where the journey includes a plurality of entities of interest (EOIs) along the journey; determine guidance information relative to the plurality of EOIs along the journey; determine a cognitive cost of the journey up to the destination based, at least in part, on the guidance information; in response to the cognitive cost of the journey up to the destination failing to satisfy a predetermined value: determine new guidance information relative to the destination having a lower cognitive cost; determine a new cognitive cost for the journey up to the destination based, at least in part, on the new guidance information relative to the destination; and in response to the cognitive cost of the journey up to the destination satisfying the predetermined value, provide the guidance information relative to the destination.

According to an example embodiment, the program code instructions to determine the cognitive cost of the journey up to the destination based, at least in part, on the guidance information further include program code instructions to determine the cognitive cost of the journey up to the destination based, at least in part, on the plurality of EOIs along the journey. The program code instructions to determine the cognitive cost of the journey up to the destination based, at least in part, on the plurality of EOIs along the journey include, in some embodiments, program code instructions to obtain a cognitive load for each of the plurality of EOIs along the journey. The program code instructions to determine the cognitive cost of the journey up to the destination based, at least in part, on the plurality of EOIs along the journey include program code instructions to determine the cognitive cost of the journey up to the destination by inputting to a cognitive model the cognitive load for each of the plurality of EOIs, a cognitive state of the operator, and the guidance information.

According to some embodiments, the program code instruction to determine guidance information relative to the destination include program code instructions to: identify gaps in understanding of information or maneuvers relative to the plurality of EOIs; and generate guidance information to fill identified gaps in understanding. The program code instructions to determine new guidance information relative to the destination having a lower cognitive cost include, in some embodiments, program code instructions to: determine the guidance information relative to the plurality of EOIs having a lower cognitive cost using operator context, a behavior model, and a cognitive model. The program code instructions to determine a cognitive cost of the journey up to the destination based, at least in part, on the guidance information include, in some embodiments, program code instructions to determine a cognitive cost for each of the plurality of EOIs, where the cognitive cost for each of the plurality of EOIs is determined based on a cognitive state of a respective EOI, a duration of the cognitive state of the respective EOI, and a weight afforded to the respective EOI. The cognitive cost for each of the plurality of EOIs is further determined, in some embodiments, based on a cognitive state transition from a previous cognitive state to the cognitive state of the respective EOI and map information associated with the respective EOI.

Embodiments provided herein include a method including: receiving an indication of a journey from an origin to a destination, where the journey includes a plurality of entities of interest (EOIs) along the journey; identifying a next entity of interest (EOI) of the plurality of EOIs; determine guidance information relative to the next EOI; determining cognitive cost of the journey up to the next EOI; in response to the cognitive cost of the journey up to the next EOI not satisfying a predetermined value: determining new guidance information relative to the next EOI having a lower cognitive cost; recalculating the cognitive cost of the journey up to the next EOI with the new guidance information relative to the EOI; and in response to the cognitive cost of the journey up to the next EOI satisfying a predetermined value, providing the guidance information relative to the next EOI to an operator.

According to some embodiments, identifying the next EOI of the plurality of EOIs includes obtaining a cognitive load for the next EOI based on historical behavior models and obtaining a current cognitive state of the operator. Determining cognitive cost of the journey up to the next EOI includes, in some embodiments, determining the cognitive cost of the journey up to the next EOI by inputting to a cognitive model the cognitive load for the next EOI, the current cognitive state of the operator, and the guidance information. Determining guidance information relative to the next EOI includes, in some embodiments, identifying gaps in understanding of information or maneuvers relative to the next EOI, and generating guidance information to fill the identified gaps in understanding. Determining new guidance information relative to the next EOI having a lower cognitive cost includes, in some embodiments, determining the guidance information relative to the next EOI having a lower cognitive cost using operator context, a behavior model, and a cognitive model.

Embodiments provided herein include an apparatus including: means for receiving an indication of a journey from an origin to a destination, where the journey includes a plurality of entities of interest (EOIs) along the journey; means for identifying a next entity of interest (EOI) of the plurality of EOIs; means for determining guidance information relative to the next EOI; means for determining cognitive cost of the journey up to the next EOI; in response to the cognitive cost of the journey up to the next EOI not satisfying a predetermined value: means for determining new guidance information relative to the next EOI having a lower cognitive cost; means for recalculating the cognitive cost of the journey up to the next EOI with the new guidance information relative to the EOI; and in response to the cognitive cost of the journey up to the next EOI satisfying a predetermined value, means for providing the guidance information relative to the next EOI to an operator.

According to some embodiments, the means for identifying the next EOI of the plurality of EOIs includes means for obtaining a cognitive load for the next EOI based on historical behavior models and obtaining a current cognitive state of the operator. The means for determining cognitive cost of the journey up to the next EOI includes, in some embodiments, means for determining the cognitive cost of the journey up to the next EOI by inputting to a cognitive model the cognitive load for the next EOI, the current cognitive state of the operator, and the guidance information. The means for determining guidance information relative to the next EOI includes, in some embodiments, means for identifying gaps in understanding of information or maneuvers relative to the next EOI, and means for generating guidance information to fill the identified gaps in understanding. The means for determining new guidance information relative to the next EOI having a lower cognitive cost includes, in some embodiments, means for determining the guidance information relative to the next EOI having a lower cognitive cost using operator context, a behavior model, and a cognitive model.

### BRIEF DESCRIPTION OF THE DRAWINGS

Having thus described certain example embodiments of the present invention in general terms, reference will hereinafter be made to the accompanying drawings which are not necessarily drawn to scale, and wherein:

FIG. 1 is a block diagram of an apparatus for reducing the cognitive cost of a journey to an operator through a reduction in the cognitive cost of guidance information according to an example embodiment of the present disclosure;

FIG. 2 is a block diagram of a system of reducing the cognitive cost of a journey to an operator through a reduction in the cognitive cost of guidance information according to an example embodiment of the present disclosure;

FIG. 3 is another block diagram of a system of reducing the cognitive cost of a journey to an operator through a reduction in the cognitive cost of guidance information according to an example embodiment of the present disclosure;

FIG. 4 illustrates a flowchart of operations for optimal guidance information generation whereby the cognitive model for navigation is integrated with the navigation system according to an example embodiment of the present disclosure;

FIG. 5 depicts a behavior and cognitive model for navigation used with a human-in-the-loop according to an example embodiment of the present disclosure;

FIG. 6 illustrates a table of chunks and the parameters of each chunk according to an example embodiment of the present disclosure;

FIG. 7 illustrates examples of states and triggers of a behavioral and cognitive model for navigation according to an example embodiment of the present disclosure; and

FIG. 8 is a flowchart of a method reducing the cognitive cost of a journey to an operator through a reduction in the cognitive cost of guidance information according to an example embodiment of the present disclosure.

### DETAILED DESCRIPTION

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

As defined herein, a “computer-readable storage medium,” which refers to a physical storage medium (e.g., volatile or non-volatile memory device), may be differentiated from a “computer-readable transmission medium,” which refers to an electromagnetic signal.

A method, apparatus and computer program product are provided in accordance with an example embodiment of the present disclosure for determining a cognitive cost to an operator for a journey, and more particularly, for reducing the cognitive cost of a journey to an operator through a reduction in the cognitive cost of guidance information. Vehicle navigation systems whether embodied by an in-vehicle navigation device such as an ADAS (Advanced Driver Assistance System, described further below) or a separate devices such as a mobile phone consider only road and route properties when assisting a human operator and does not consider the operation of the vehicle as a “human-in-the-loop” system. Vehicle navigational assistance can be in the form of visual and/or auditory cues providing various elements of information to a vehicle operator. This navigational assistance can be overwhelming to a vehicle operator, and can put undue stress on a vehicle operator as they proceed along a route, particularly when the route is through a complex path with closely-spaced navigation instructions. The cognitive load distribution and the cognitive cost involve in the guidance is not factored in to when and what guidance information should be presented to the operator.

Cognitive effort in the form of listening to or looking at navigational instructions while also processing objects and stimuli in environments can be mentally taxing and can lead to mental fatigue. Cognitive cost is the amount of cognitive effort that a particular task requires. A high cumulative cognitive cost can have a negative impact on a user. Vehicle systems need to convey various types and amounts of information to a user, and the user must be able to process the information they are receiving. However, the cognitive cost of the information provided to a user is often not contemplated when determining what information to provide to a user and when to provide it.

A navigational system in a vehicle can present to the user on a user interface a current location on the map and provide both audio and visual information providing guidance from traveling from one location to another. Embodiments provided herein identify the cognitive cost of information provided to a user and establish how to give an operator of a vehicle adequate navigation information with minimal interruption. Embodiments described herein address at least three issues relating to cognitive load including: given a set of route and map information, determine optimal guidance information for the user; provided a set of inputs to create guidance information, determine the optimal guidance information; and determine what guidance information must be given to the user and how.

Optimal guidance information, as described herein, eliminates or at least reduces the driver distraction created by a navigational system. To develop optimal guidance information requires an understanding of the cognitive load placed on an operator. Cognitive models enable the understanding of operator thoughts while driving and enable the extraction of a current and a target cognitive state of the operator. Identification of past, current, and target cognitive states of the operator while driving helps to deduct the root causes for increased cognitive load as well as the creation of guidance information that addresses the route cause in a more effective way. Embodiments described herein creates and integrates cognitive models for navigation with enhanced behavior models that can be together visualized as Behavior and Cognitive Models for Navigation (BCMN). Cognitive model sin BCMN are created using ACT-R (Adaptive Control of Thought—Rational) which is a cognitive architecture for understanding and modeling the human cognition process. A machine learning suite can be employed for creation of static and dynamic behavior models. Static behavior models are created by embodiments described herein based on statistical surveys which include questions in areas such as: driver distraction by the navigation system, extent to which the navigation system understands user intentions, and optimal integration between the user and the navigational system. Dynamic behavior models are recreated every time a new user behavior is observed. Dynamic behavior models are created based on the user context and the measured user cognitive load for context. Embodiments described herein use the behavior models to create cognitive models for use in determining optimum guidance information for an operator.

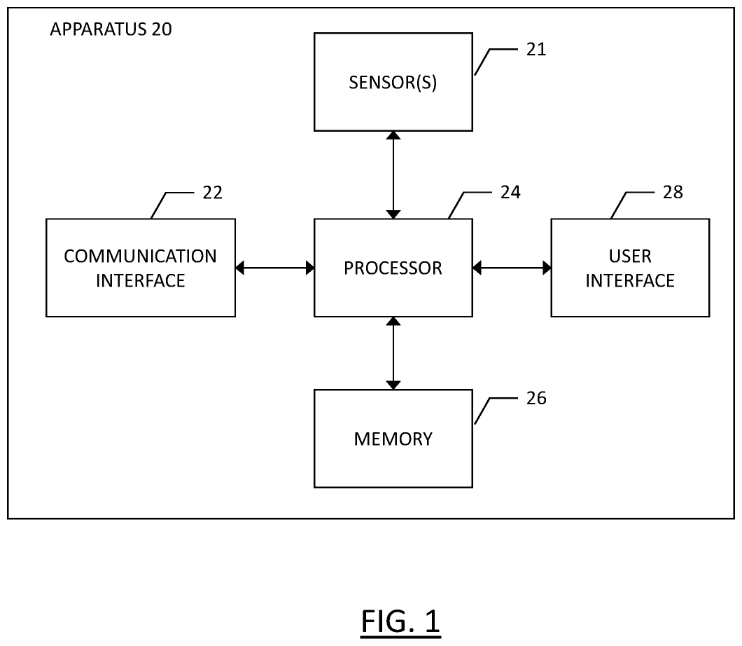

FIG. 1 is a schematic diagram of an example apparatus configured for performing any of the operations described herein. Apparatus 20 is an example embodiment that may be embodied by or associated with any of a variety of computing devices that include or are otherwise associated with a device configured for providing a navigation system or infotainment system user interface. For example, the computing device may be a mobile terminal, such as a personal digital assistant (PDA), mobile telephone, smart phone, personal navigation device, smart watch, tablet computer, camera or any combination of the aforementioned and other types of voice and text communications systems. Optionally, the computing device may be a fixed computing device, such as a built-in vehicular navigation device, assisted driving device, or the like.

Optionally, the apparatus may be embodied by or associated with a plurality of computing devices that are in communication with or otherwise networked with one another such that the various functions performed by the apparatus may be divided between the plurality of computing devices that operate in collaboration with one another.

The apparatus 20 may be equipped with any number of sensors 21, such as a global positioning system (GPS), accelerometer, and/or gyroscope. Any of the sensors may be used to sense information regarding the movement, positioning, or orientation of the device for use in navigation assistance, as described herein according to example embodiments. In some example embodiments, such sensors may be implemented in a vehicle or other remote apparatus, and the information detected may be transmitted to the apparatus 20, such as by near field communication (NFC) including, but not limited to, Bluetooth™ communication, or the like.

The apparatus 20 may include, be associated with, or may otherwise be in communication with a communication interface 22, processor 24, a memory device 26 and a user interface 28. In some embodiments, the processor (and/or co-processors or any other processing circuitry assisting or otherwise associated with the processor) may be in communication with the memory device via a bus for passing information among components of the apparatus. The memory device may be non-transitory and may include, for example, one or more volatile and/or non-volatile memories. In other words, for example, the memory device may be an electronic storage device (for example, a computer readable storage medium) comprising gates configured to store data (for example, bits) that may be retrievable by a machine (for example, a computing device like the processor). The memory device may be configured to store information, data, content, applications, instructions, or the like for enabling the apparatus to carry out various functions in accordance with an example embodiment of the present invention. For example, the memory device could be configured to buffer input data for processing by the processor. Additionally or alternatively, the memory device could be configured to store instructions for execution by the processor.

As noted above, the apparatus 20 may be embodied by a mobile device. However, in some embodiments, the apparatus may be embodied as a chip or chip set. In other words, the apparatus may comprise one or more physical packages (for example, chips) including materials, components and/or wires on a structural assembly (for example, a circuit board). The structural assembly may provide physical strength, conservation of size, and/or limitation of electrical interaction for component circuitry included thereon. The apparatus may therefore, in some cases, be configured to implement an embodiment of the present invention on a single chip or as a single “system on a chip.” As such, in some cases, a chip or chipset may constitute means for performing one or more operations for providing the functionalities described herein.

The processor 24 may be embodied in a number of different ways. For example, the processor may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor may include one or more processing cores configured to perform independently. A multi-core processor may enable multiprocessing within a single physical package. Additionally or alternatively, the processor may include one or more processors configured in tandem via the bus to enable independent execution of instructions, pipelining and/or multithreading.

In an example embodiment, the processor 24 may be configured to execute instructions stored in the memory device 26 or otherwise accessible to the processor. Alternatively or additionally, the processor may be configured to execute hard coded functionality. As such, whether configured by hardware or software methods, or by a combination thereof, the processor may represent an entity (for example, physically embodied in circuitry) capable of performing operations according to an embodiment of the present invention while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions may specifically configure the processor to perform the algorithms and/or operations described herein when the instructions are executed. However, in some cases, the processor may be a processor of a specific device (for example, the computing device) configured to employ an embodiment of the present invention by further configuration of the processor by instructions for performing the algorithms and/or operations described herein. The processor may include, among other things, a clock, an arithmetic logic unit (ALU) and logic gates configured to support operation of the processor.

The apparatus 20 of an example embodiment may also include or otherwise be in communication with a user interface 28. The user interface may include a touch screen display, a speaker, a plurality of spatially arranged speakers, headphones, ear bud speakers, physical buttons, and/or other input/output mechanisms. The user interface 28 may be incorporated into a vehicle, such as a dedicated navigation system display/audio system or a device that can attach or associate with the vehicle physically and/or via a wireless communication link. In an example embodiment, the processor 24 may comprise user interface circuitry configured to control at least some functions of one or more input/output mechanisms. The processor and/or user interface circuitry comprising the processor may be configured to control one or more functions of one or more input/output mechanisms through computer program instructions (for example, software and/or firmware) stored on a memory accessible to the processor (for example, memory device 26, and/or the like). In this regard, the apparatus 20 may provide spatial auditory cues via speakers, headphones, earbuds, or the like, to a user to convey information and a relevant location, for example.

The apparatus 20 of an example embodiment may also optionally include a communication interface 22 that may be any means such as a device or circuitry embodied in either hardware or a combination of hardware and software that is configured to receive and/or transmit data from/to other electronic devices in communication with the apparatus, such as by NFC, described above. Additionally or alternatively, the communication interface 22 may be configured to communicate over Global System for Mobile Communications (GSM), such as but not limited to Long Term Evolution (LTE) and/or the fifth generation technology standard for broadband cellular networks, 5G. In this regard, the communication interface 22 may include, for example, an antenna (or multiple antennas) and supporting hardware and/or software for enabling communications with a wireless communication network. Additionally or alternatively, the communication interface 22 may include the circuitry for interacting with the antenna(s) to cause transmission of signals via the antenna(s) or to handle receipt of signals received via the antenna(s). In some environments, the communication interface 22 may alternatively or also support wired communication may alternatively support vehicle to vehicle or vehicle to infrastructure wireless links.

The apparatus 20 may support a mapping application so as to present maps or otherwise provide navigation assistance. In order to support a mapping application, the computing device may include or otherwise be in communication with a geographic database, such as may be stored in memory device 26. For example, the geographic database includes node data records, road segment or link data records, point of interest (POI) data records, and other data records. More, fewer or different data records can be provided. In one embodiment, the other data records include cartographic data records, routing data, and maneuver data. One or more portions, components, areas, layers, features, text, and/or symbols of the POI or event data can be stored in, linked to, and/or associated with one or more of these data records. For example, one or more portions of the POI, event data, or recorded route information can be matched with respective map or geographic records via position or GPS data associations (such as using known or future map matching or geo-coding techniques), for example. Furthermore, other positioning technology may be used, such as electronic horizon sensors, radar, lidar, ultrasonic and/or infrared sensors.

In example embodiments, a navigation system user interface may be provided to provide route guidance from an origin to a destination. Navigation systems may receive an indication of an origin, which may include a current location of a device on which the navigation system is operating (e.g., an in-vehicle navigation system or a mobile device, for example), and an indication of a destination where the user of the navigation system is going. In response to receiving the origin and destination pair, a route may be generated between the origin and destination. The route may be generated according to user preferences for fastest travel time, minimizing highways (e.g., limited access high-speed roadways), maximizing highways, shortest distance, etc. Further, waypoints may be provided between the origin and destination, or a route may include multiple, sequential destinations. Example embodiments provided herein may be used for a navigation system user interface to provide route guidance to the first destination, the last destination, or the ultimate destination with waypoints indicated in the route guidance from the origin and possibly points of interest along the route.

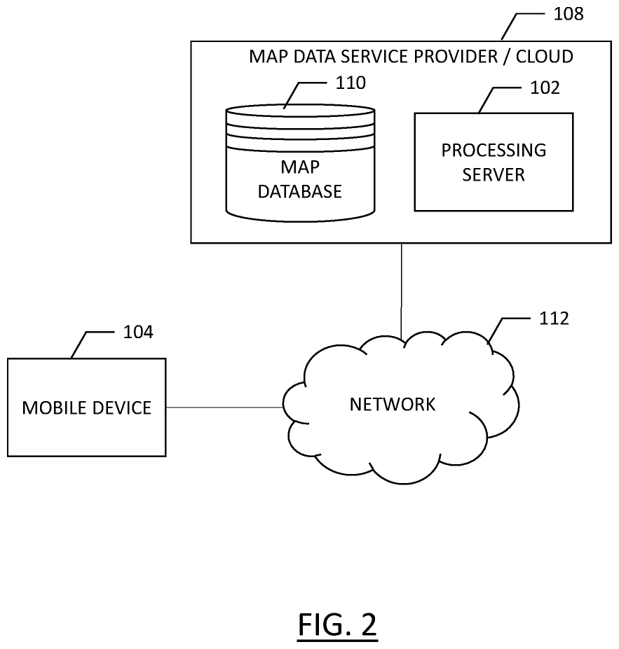

A map service provider database may be used to provide route guidance to a navigation system. FIG. 2 illustrates a communication diagram of an example embodiment of a system for implementing example embodiments described herein. The illustrated embodiment of FIG. 2 includes a mobile device 104, which may be, for example, the apparatus 20 of FIG. 1, such as a mobile phone, an in-vehicle navigation system, the vehicle itself, or the like, and a map data service provider or cloud service 108. Each of the mobile device 104 and map data service provider 108 may be in communication with at least one of the other elements illustrated in FIG. 2 via a network 112, which may be any form of wireless or partially wireless network as will be described further below. Additional, different, or fewer components may be provided. For example, many mobile devices 104 may connect with the network 112. The map data service provider 108 may be cloud-based services and/or may operate via a hosting server that receives, processes, and provides data to other elements of the system.

The map data service provider 108 may include a map database 110 that may include node data, road segment data or link data, point of interest (POI) data, traffic data or the like. The map database 110 may also include cartographic data, routing data, and/or maneuvering data. The map data can be organized in different map layers. According to some example embodiments, the road segment data records may be links or segments representing roads, streets, or paths, as may be used in calculating a route or recorded route information for determination of one or more personalized routes. The node data may be end points (such as representing intersections) corresponding to the respective links or segments of road segment data. The road link data and the node data may represent a road network, such as used by vehicles, cars, trucks, buses, motorcycles, and/or other entities. Optionally, the map database 110 may contain path segment and node data records or other data that may represent pedestrian paths or areas in addition to or instead of the vehicle road record data, for example. The road/link segments and nodes can be associated with attributes, such as geographic coordinates, street names, address ranges, speed limits, turn restrictions at intersections, and other navigation related attributes, as well as POIs, such as fueling stations, hotels, restaurants, museums, stadiums, offices, auto repair shops, buildings, stores, parks, etc. The map database 110 can include data about the POIs and their respective locations in the POI records. The map database 110 may include data about places, such as cities, towns, or other communities, and other geographic features such as bodies of water, mountain ranges, etc. Such place or feature data can be part of the POI data or can be associated with POIs or POI data records (such as a data point used for displaying or representing a position of a city). In addition, the map database 110 can include event data (e.g., traffic incidents, construction activities, scheduled events, unscheduled events, etc.) associated with the POI data records or other records of the map database 110.

The map database 110 may be maintained by a content provider e.g., the map data service provider and may be accessed, for example, by the content or service provider processing server 102. By way of example, the map data service provider can collect geographic data and dynamic data to generate and enhance the map database 110 and dynamic data such as traffic-related data contained therein. There can be different ways used by the map developer to collect data. These ways can include obtaining data from other sources, such as municipalities or respective geographic authorities, such as via global information system databases. In addition, the map developer can employ field personnel to travel by vehicle along roads throughout the geographic region to observe features and/or record information about them, for example. Also, remote sensing, such as aerial or satellite photography and/or LIDAR, can be used to generate map geometries directly or through machine learning as described herein. However, the most ubiquitous form of data that may be available is vehicle data provided by vehicles, such as mobile device 104, as they travel the roads throughout a region.

The map database 110 may be a master map database stored in a format that facilitates updates, maintenance, and development. For example, the master map database or data in the master map database can be in an Oracle spatial format or other spatial format, such as for development or production purposes. The Oracle spatial format or development/production database can be compiled into a delivery format, such as a geographic data files (GDF) format. The data in the production and/or delivery formats can be compiled or further compiled to form geographic database products or databases, which can be used in end user navigation devices or systems.

For example, geographic data may be compiled (such as into a platform specification format (PSF) format) to organize and/or configure the data for performing navigation-related functions and/or services, such as route calculation, route guidance, map display, speed calculation, distance and travel time functions, and other functions, by a navigation device, such as by a vehicle represented by mobile device 104, for example. The navigation-related functions can correspond to vehicle navigation, pedestrian navigation, or other types of navigation. While example embodiments described herein generally relate to vehicular travel along roads, example embodiments may be implemented for pedestrian travel along walkways, bicycle travel along bike paths, boat travel along maritime navigational routes, etc. The compilation to produce the end user databases can be performed by a party or entity separate from the map developer. For example, a customer of the map developer, such as a navigation device developer or other end user device developer, can perform compilation on a received map database in a delivery format to produce one or more compiled navigation databases.

As mentioned above, the map data service provider 108 map database 110 may be a master geographic database, but in alternate embodiments, a client side map database may represent a compiled navigation database that may be used in or with end user devices (e.g., mobile device 104) to provide navigation and/or map-related functions. For example, the map database 110 may be used with the mobile device 104 to provide an end user with navigation features. In such a case, the map database 110 can be downloaded or stored on the end user device which can access the map database 110 through a wireless or wired connection, such as via a processing server 102 and/or the network 112, for example.

In one embodiment, as noted above, the end user device or mobile device 104 can be embodied by the apparatus 20 of FIG. 1 and can include an in-vehicle navigation system, such as an ADAS (advanced driver assistance system), a personal navigation device (PND), a portable navigation device, a cellular telephone, a smart phone, a personal digital assistant (PDA), a watch, a camera, a computer, and/or other device that can perform navigation-related functions, such as digital routing and map display. An end user can use the mobile device 104 for navigation and map functions such as guidance and map display, for example, and for determination of one or more personalized routes or route segments based on one or more calculated and recorded routes, according to some example embodiments.

An ADAS may be used to improve the comfort, efficiency, safety, and overall satisfaction of driving. Examples of such advanced driver assistance systems include semi-autonomous driver assistance features such as adaptive headlight aiming, adaptive cruise control, lane departure warning and control, curve warning, speed limit notification, hazard warning, predictive cruise control, adaptive shift control, among others. Other examples of an ADAS may include provisions for fully autonomous control of a vehicle to drive the vehicle along a road network without requiring input from a driver. Some of these advanced driver assistance systems use a variety of sensor mechanisms in the vehicle to determine the current state of the vehicle and the current state of the roadway ahead of the vehicle. These sensor mechanisms may include radar, infrared, ultrasonic, and vision-oriented sensors such as image sensors and light distancing and ranging (LiDAR) sensors.

Some advanced driver assistance systems may employ digital map data. Such systems may be referred to as map-enhanced ADAS. The digital map data can be used in advanced driver assistance systems to provide information about the road network, road geometry, road conditions, and other information associated with the road and environment around the vehicle. Unlike some sensors, the digital map data is not affected by the environmental conditions such as fog, rain, or snow. Additionally, the digital map data can provide useful information that cannot reliably be provided by sensors, such as curvature, grade, bank, speed limits that are not indicated by signage, lane restrictions, and so on. Further, digital map data can provide a predictive capability well beyond the driver's vision to determine the road ahead of the vehicle, around corners, over hills, or beyond obstructions. Accordingly, the digital map data can be a useful and sometimes necessary addition for some advanced driving assistance systems. In the example embodiment of a fully-autonomous vehicle, the ADAS uses the digital map data to determine a path along the road network to drive, such that accurate representations of the road are necessary, such as accurate representations of intersections and turn maneuvers there through. While a “driver” is referenced herein, a driver may optionally refer to an occupant of a vehicle, or an occupant that is commanding/controlling an autonomous vehicle, for example.

Route guidance from an origin to a destination may be communicated to a user through visual and/or auditory cues including audible instructions. Beyond route guidance, other information or instructions may also be communicated via auditory cues or visual depictions on a user interface. For example, point out points-of-interest, cautioning a driver/rider of upcoming traffic, delays, or alternate routes, or indicating other useful information may be communicated to a user. Auditory cues are typically synthesized voice instructions that deliver spoken instructions to a driver. In the context of navigation, these spoken instructions are often regarding a next upcoming maneuver required to stay on a route to a destination. Navigation systems and routing engines may determine decision points within the road network corresponding to maneuvers, and these decision points may be provided to a text-to-speech engine for converting the maneuvers into spoken instructions. Spoken instructions may be the communication channel of choice, as opposed to written instructions on a display or visual instructions on a display, to improve safety, as the driver may be using their vision for the task of driving. However, auditory cues and visual indications on a display may be provided to enable a vehicle operator to reference their instruction of choice.

As a vehicle operator travels through an environment, there are different factors that contribute to a cognitive load on the operator. Some external cognitive load factors cannot be controlled, such as traffic, poor drivers, signage along a road, or other environmental factors that are out of the control of a vehicle operator or a vehicle service provider such as the map data service provider 108. When a vehicle is traveling along a route using navigational assistance, the route guidance provided by the navigation system can contribute to the cognitive load of the journey to the destination. The route guidance provided by the navigation is a cognitive load factor that can be optimized to reduce the cognitive load on a vehicle operator during the journey. To optimize the cognitive load, an understanding of the overall cognitive load of the operator is needed.

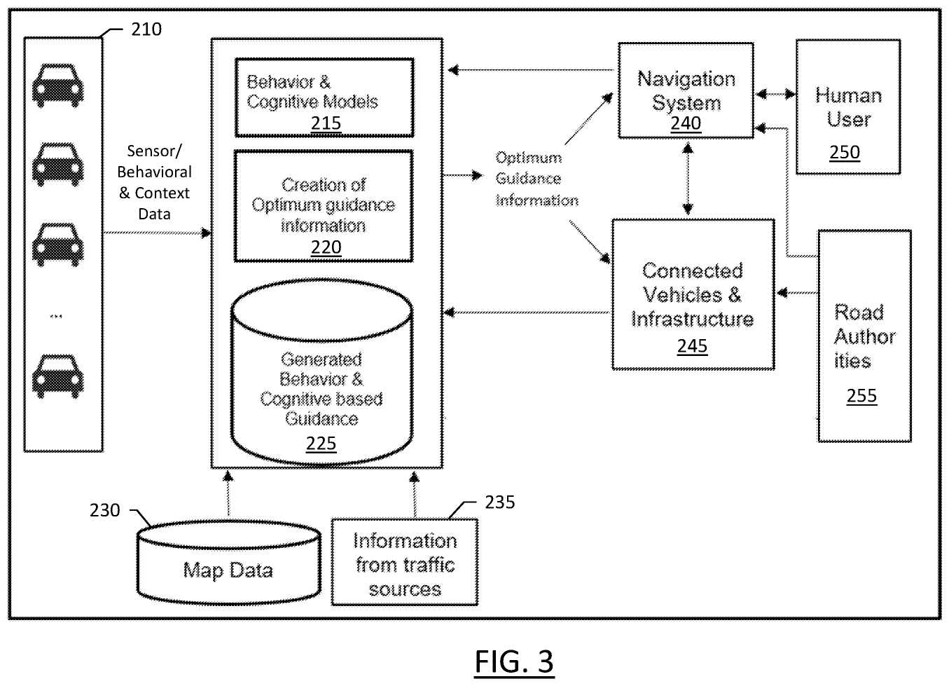

The cognitive cost patterns for navigation are generated for the operator based on a number of inputs. These inputs include behavior models, cognitive models, contexts, external inputs (e.g., traffic information), and cognitive state information. The cognitive cost reduction algorithms described herein are applied to create the minimal cognitive cost patterns which are used for navigation. A system of example embodiments is illustrated in FIG. 3.

The behavior and cognitive models 215 are learned from a variety of input data sources, such as sensor data, behavioral data, and context data received from a plurality of probes which include, for example, vehicles 210 represented by navigation systems, mobile devices, or the like. Additional data for the behavior and cognitive models can be received from a human user 250, such as via a navigational system 240. Behavior and cognitive models can further be enhanced with road authority 255 information that can be provided to the navigation system 240 and to connected vehicles and infrastructure 245. The information from the road authorities 255 to the navigation system 240 and connected vehicles and infrastructure 245 can include road/lane closures, traffic information, toll information, etc.

Route guidance information can be generated from map data 230 and information from traffic sources 235, such as via a map data service provider. Based on the route guidance information and the behavior and cognitive models 215, optimum guidance information is created at 220 with the generated behavior and cognitive based guidance stored at 225. This optimum guidance information is provided to one or both of a navigation system 240 and/or connected vehicles and infrastructure 245. Additional details regarding the creation of the optimum guidance information is provided below.

Optimum guidance information as described herein is guidance information that considered the total cognitive load on a vehicle operator, and adjusts route guidance information to avoid overwhelming the vehicle operator during a journey. This optimum guidance information is a balance between providing sufficient information to an operator and overwhelming an operator with too much information or too much information when their cognitive load is already high from external factors. Embodiments described herein consider a cognitive load across a complete journey to establish what information can be conveyed to a user through route guidance without producing too great of a cognitive load.

Embodiments described herein provide an algorithm for automatic generation of optimum guidance information. Inputs to the algorithm include behavioral models, cognitive models (from behavior and cognitive models 215 of FIG. 3), route information, map information (e.g., from map data 230), cognitive state information and cognitive state transition information (e.g., from human user 250), duration of each cognitive state, and other information such as traffic data, road closures, etc. (e.g., from road authorities 255). The output is the optimum guidance information based on minimum cognitive cost pattern for a journey.

According to embodiments of the algorithm described herein, sensor data is gathered from vehicles along with behavioral data and context data. Sensor data includes data from sensors of a vehicle, such as LiDAR (Light Distancing and Ranging), radar, image sensors, etc. This sensor data can provide information regarding the environment of the vehicle which is extracted to constitute context data. Behavioral data can be obtained from vehicle inputs received from an operator, such as a speed of the vehicle, sharpness or frequency of lane changes, music type, music volume, etc. From this data, behavior and context-based machine learning models are created using context information that factor in behavioral data, existing map data (e.g., to identify map features), and dynamic map data (e.g., to identify weather conditions and traffic conditions).

Cognitive models for navigation also created. These cognitive models identify cognitive cost of different elements of route guidance. Each instruction provided to an operator or element of information provided to an operator has associated therewith a cognitive cost. For example, a multi-step instruction for turns, such as “turn left on Main Street and then turn right on East Avenue” can have a high cognitive load as the instructions involve two separate actions (turn left and turn right) and two separate identifiers (Main Street and East Avenue). This information can be overwhelming to a operator, particularly in a scenario in which traffic is dense and the operator is concerned about moving to the appropriate lane. Other guidance information can be of lower cognitive cost, but still has a cognitive cost to some degree. For instance, a piece of information such as “caution: traffic ahead” can have a low cognitive cost as a simple instruction, but may impart a relatively high cognitive cost if it is raising the concern of the operator. Thus, cognitive models identify what instructions have their own cognitive cost. Further, the cognitive models can use as inputs context and environment of a vehicle to further identify the cognitive cost of specific guidance information at specific locations. For example, a route guidance instruction provided to an operator along a low-traffic highway will have a lower cognitive cost than a substantially equivalent route guidance instruction provided to an operator in a dense, high-traffic urban environment.

Cognitive cost for a route is calculated on a variety of inputs including: behavioral models (e.g., modeling operator behavior), cognitive models (e.g., modeling cognitive cost of the route and incremental points along the route), route information (e.g., a series of road segments from an origin to a destination including decision points along the way), map information (e.g., road density, road speed limits, road environment (urban/rural), etc.) cognitive state information (e.g., the cognitive state of an operator at different points along a route), cognitive state transition information (e.g., a point where an operator's cognitive state increases in intensity/cost or decreases in intensity/cost by a predetermined measure), duration of each cognitive state (e.g., the time between cognitive state transitions), and other information such as dynamic traffic, dynamic weather, etc.

The total cognitive cost calculation for navigation along a route of a journey can be calculated by the following equation:

$$C 3 N = {\sum }_{i = 0}^{N} \{ Si , Di , Wn , T ( i - 1 ) , Mi , Oi \}$$

Where C3N is the total cognitive cost; Si is the cognitive state; Di is the duration of the cognitive state; Wi is a weighting factor of the cognitive state; T(i−1) is the weighting factor of the cognitive state transition from the previous cognitive state; Mi is the map information, and Oi is the other information. The equation above calculates the total cognitive cost for a total journey. However, for particularly long journeys (e.g., 1+hours, 2+hours, etc.), the journeys may be broken up into sub-sections of the journey where total cognitive cost can be calculated for each sub-section.

Calculation of the cognitive cost by considering the journey as a whole instead of calculating the cognitive cost independently corresponding to individual locations accounts for the cumulative cognitive load on an operator along a journey. This calculation enables identification and optimization of the cognitive load not only by considering the present context of the operator, but also factors from the past in the form of the generated models.

Upon calculation of the cumulative cognitive cost (C3N), it is determined if the cognitive cost is sub-optimal. Sub-optimal may be established based on a predetermined cognitive threshold beyond which the cognitive cost is considered too high and potentially mentally exhausting for an operator. The predetermined cognitive threshold can be a universally-established metric that is a cognitive cost above which a large percentage (e.g., 90% of operators) begin to become mentally exhausted. Optionally, the predetermined cognitive threshold can be user-specific, with the cognitive threshold for an individual learned over time as to what their threshold is for cognitive cost before reaching mental exhaustion.

If the calculated cognitive cost is above the predetermined threshold, embodiments employ a cognitive cost optimality algorithm. This algorithm is generated based on feedback for route guidance information in addition to models that establish the cognitive cost of guidance information elements as noted above. Using feedback on the guidance information, models are updated which trigger reconfiguration of optimum guidance information. This operation helps to adapt to new user behavior as well as to correct any errors in the original route guidance generation. The optimality information is updated as needed to produce route guidance with a lower cognitive cost.

The cognitive cost optimization algorithm applies optimization across the whole journey instead of treating individual high cognitive load points for the journey independently. Treating individual high cognitive load points for the journey independently and reducing their cognitive cost can increase cognitive cost elsewhere along the journey. According to an example embodiment, a user may travel from point A to point B. The cognitive cost calculation for the journey which may include three main points of calculation of P1, P2, and P3, with the cognitive cost at each point being C1, C2, and C3. To optimize the cognitive cost C2 at P2, the algorithm not only considers the context corresponding to P2, but also the context and cognitive load information C1 from P1 also. Similarly, in order to optimize the cognitive cost C3 at P3, the algorithm not only considers the context corresponding to P3, but also considers the context and cognitive load information C1 and C2 from points P1 and P2, also.

Points of calculation along a journey can include maneuvers, areas or points-of-interest, travel through densely populated areas, or the like. According to an example embodiment, an entity-of-interest (EOI) may be considered a calculation point for establishing cognitive load. EOIs can include any maneuvers (e.g., turns, lane changes, etc.), points-of-interest (e.g., addresses, businesses, recreational facilities, restaurants, transit stops, attractions, etc.), or any other element for which information may be provided to an operator. An example EOI may include a bust stop which is a point-of-interest (POI), a school that is another POI, and a pedestrian crossing signal which may be a third POI. This information is from map data. Using the equation above, POIM1 is the Bus stop, POIM2 is the school, and POIM3 is the pedestrian crossing signal. The POI Relationship (POIR) may include the bus stop within a predefined radius, routing between the school and the bus stop including the pedestrian crossing, irrespective of the signal state (Red/Green) since the garget group includes children. The weight (7) of a change in cognitive state can include lunch break time and dismissal time, as at those times the bus stop, pedestrian crossing, and school will be hubs of pedestrian activity. The other information (O) can include, for example, reduced visibility by fog, current traffic speed conditions, etc.

The generation of optimum navigation information for an example embodiment can be represented by a human model (HM), route characteristics (RC), and an EOI, where the EOI is represented by: EOI={POIM1, POIM2, POIM3 . . . , POIn, POIR, T, O}. POI1, POIM2 . . . , POIn are multiple POIs represented by the models of the same. The models of the POIs also include the dynamic and static aspects of the respective POI. POIR is the relationship between the multiple POIS, with the time (T) and other information (O) needed for the creation of the EOI.

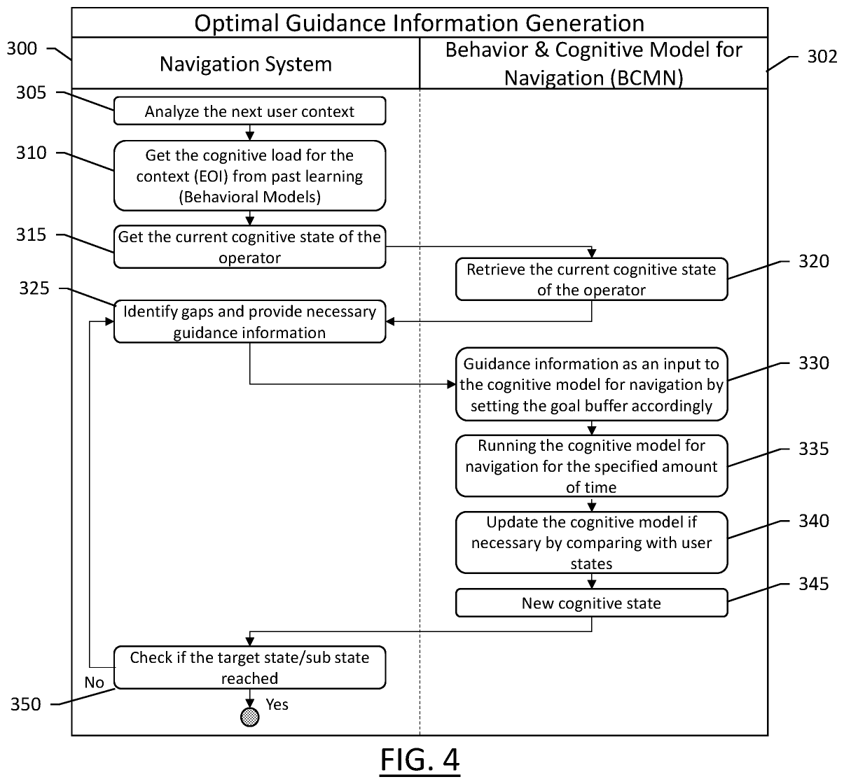

FIG. 4 illustrates a flowchart of operations for optimal guidance information generation whereby the cognitive model for navigation is integrated with the navigation system. The operations illustrated in FIG. 4 are repeated for every EOI during the navigation process. The navigation system receives inputs for generating the next guidance information including: current cognitive state of the user from BCMN, cognitive load for the next EOI as per previous learning, and characteristics of the next EOI for which the user might need guidance information. A route is generated from an origin to a destination, such as by the navigation system 300 or map data service provider 108. The next user context along the route is analyzed at 305. The cognitive load for the context (EOI) from past learning (e.g., behavior models) is obtained at 310. The current cognitive state of the operator is obtained at 315. The current cognitive state of the operator is established at 320 in the behavior and cognitive model for navigation 302 and fed back to the navigation system 300. Gaps are identified at 325, where gaps are parts of route guidance lacking sufficient instruction for an operator. Guidance information is provided to fill the identified gaps at 325.

The guidance information is provided as an input to the cognitive model for navigation by setting the goal buffer accordingly at 330. The goal buffer is an interface to a goal module that can hold chunks of data. The cognitive model for navigation is run for the specified amount of time at 335. If necessary, the cognitive model is updated by comparing the cognitive model output with user states, and a new cognitive state is identified as necessary. At 350, a determination is made as to whether the target cognitive state or sub-state is reached, with the target state being a cognitive load below a predetermined threshold. If the cognitive load is above the threshold, the process returns to operation 325 to identify gaps and to provide necessary guidance information based on the cognitive state established at 345 until the target cognitive state is reached at 350.

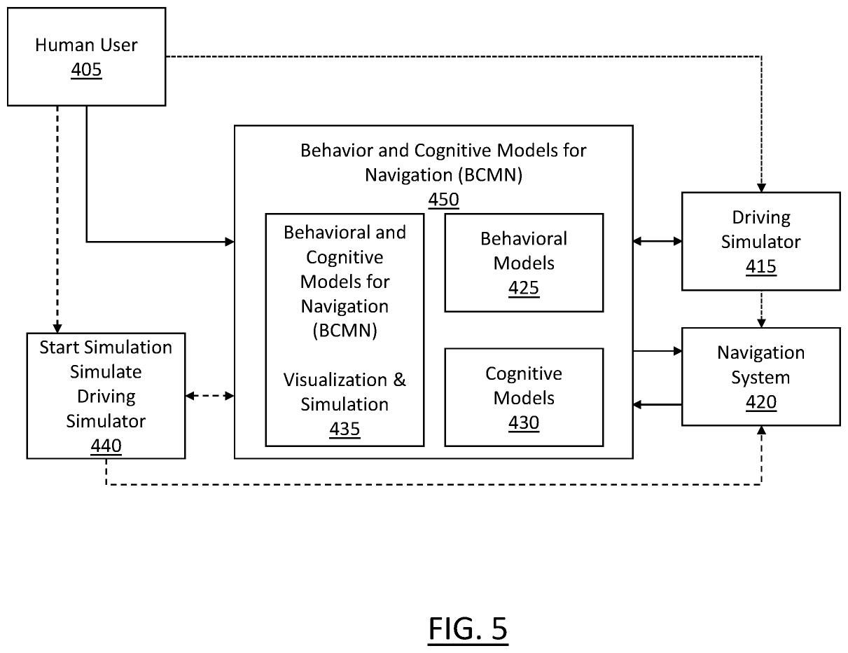

The Behavior and Cognitive Models for Navigation is illustrated in FIG. 5 which illustrates components used to establish training data using human-in-the-loop systems to collect behavioral data and based on that data, find user cognitive load points and optimize machine learning behavioral models which are used by the system to understand a user.

As shown, the human user 405 providing input directly to the BCMN 450 and using a driving simulator 415 from which behavioral models are learned. The navigation system provides input for BCMN 450 while receiving feedback based on the output of the BCMN and receiving input from the driving simulator 415. A simulated driving simulator 440 provides a machine learning model to mimic the human user 405 driving in an environment and provides and receives data to and from the BCMN. The BCMN 450 itself includes the behavioral models 425, the cognitive models 430, and the BCMN visualization and simulation 435. The purpose of the BCMN is to identify the cognitive load and root cause by using static behavior models, dynamic behavior models, and human cognitive models for navigation. The driving simulator 415 is a simulator primarily designed for developing and testing autonomous driving agents, where inputs from the driving simulator are used by the BCMN 450 for obtaining driver context information. The navigation system 420 tracks car position in the route and highlights the path taken by the human user. The navigation system also presents the guidance information to the user as per the input from the BCMN as well as based on the current driver context. The inputs from the navigation system are used by the BCMN for getting the driving context information. The simulator for driving simulator 440 enables faster learning using machine learning that can be implemented without the physical driving simulator 415. Embodiments aim to give the human user adequate navigation information with minimal interruption.

A hybrid cognitive architecture model is created for the navigation process and implemented with programming. An example provided herein uses the ACT-R (Adaptive Control of Thought—Rational) based cognitive architecture and LISP programming language for implementation. Declarative, Goal, and Procedure models provided by ACT-R may be employed by example embodiments described herein. ACT-R based cognitive architecture is a specification of the structure of the brain at a different level of abstraction necessary enough to describe the function of the mind. Different ACT-R models are associated with corresponding brain regions. The Declarative module holds and retrieves critical information from the memory and the Goal module keeps track of current user interactions. Communication among these modules is achieved by using the Procedural modules. In ACT-R, chunks represent knowledge a user already has while solving a problem. Chunks can also be visualized as small units that contain small amounts of information. Sub-symbolic level activation of the chunks and utility-based rule selection of the production module can be used for enabling learning for the created cognitive model.

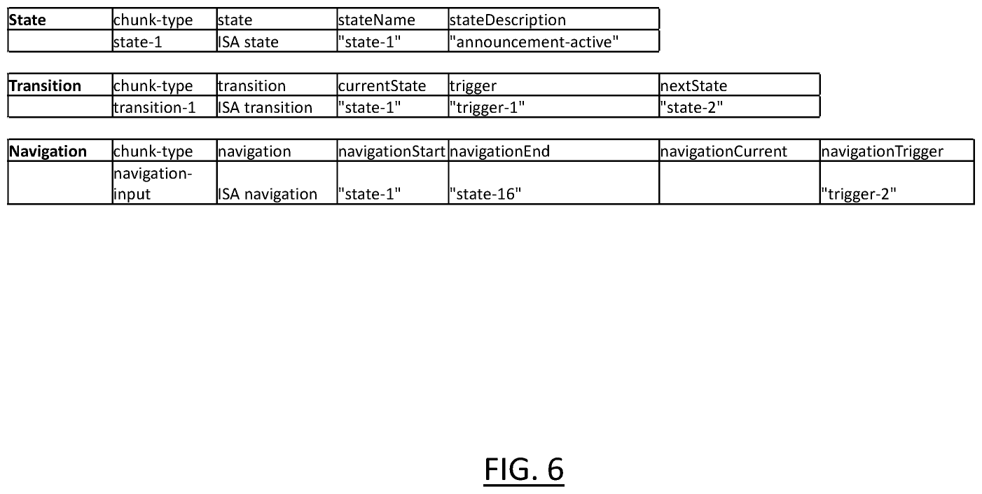

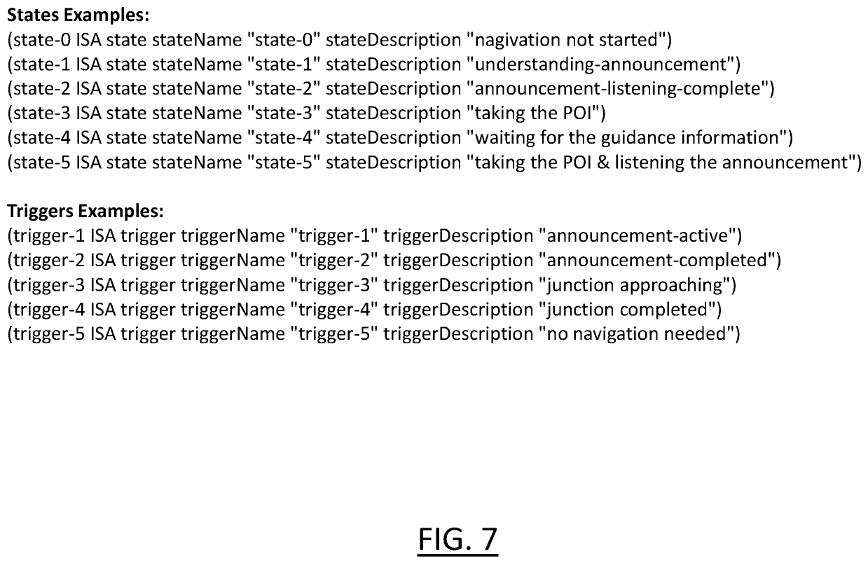

The Declarative module in the cognitive model for navigation of embodiments described herein includes primarily the following chunk types illustrated in FIG. 6. A “state” chunk type is used for representing the existing knowledge of a user about different cognitive states for navigation (e.g., “announcement-active”, “understanding-announcement”). A transition chunk type including the current state, trigger, and next state represents the existing knowledge of the user about the state transition based on a trigger. The navigation chunk type represents the existing knowledge of the user about the navigation state as well as transition based on the trigger. The navigation chunk type is also used to set the contents of the goal buffer which acts as one of the interfaces to the cognitive model. The cognitive state of the user can be used by the navigation system for deciding the next guidance information as well as deciding when to present the next guidance information. ACT-R production rules contain the condition and corresponding action. Conditions specify the patterns in the buffer associated with different modules that must be matched for the production to fire. FIG. 7 illustrates several additional examples of States and Triggers of embodiments provided herein.

Embodiments disclosed herein include human-in-the-loop experiments with BCMN enhancement to improve the cognitive models. The input for the process is a candidate drive between two selected points on a map. The output is optimized guidance information generated using the driver context, behavior models, and human cognitive models. The operations include selecting two points in the map for conducting the human experiments for evaluation of optimum guidance information. Candidate drives are collected between the selected points. Guidance information is generated and presented for every user context (EOI) based on current behavior models, user contexts, and cognitive state. The behavioral data is collected for updating the behavior models per the latest behavior observed for the EOI. Once the destination is reached for a candidate drive, behavioral data collection stops. The behavioral data is used as an input to a benchmarking tool. The benchmarking tool creates any necessary logs for driving behavior. Cognitive load is measured at different contexts of driving (EOI) and a report is created. The driving behavior is replayed to verify the findings from the report. Driver cognition state for EOIs from the cognitive models is reverified and enhanced when necessary. Cognitive load values at different points are used to recreate the dynamic behavioral models.

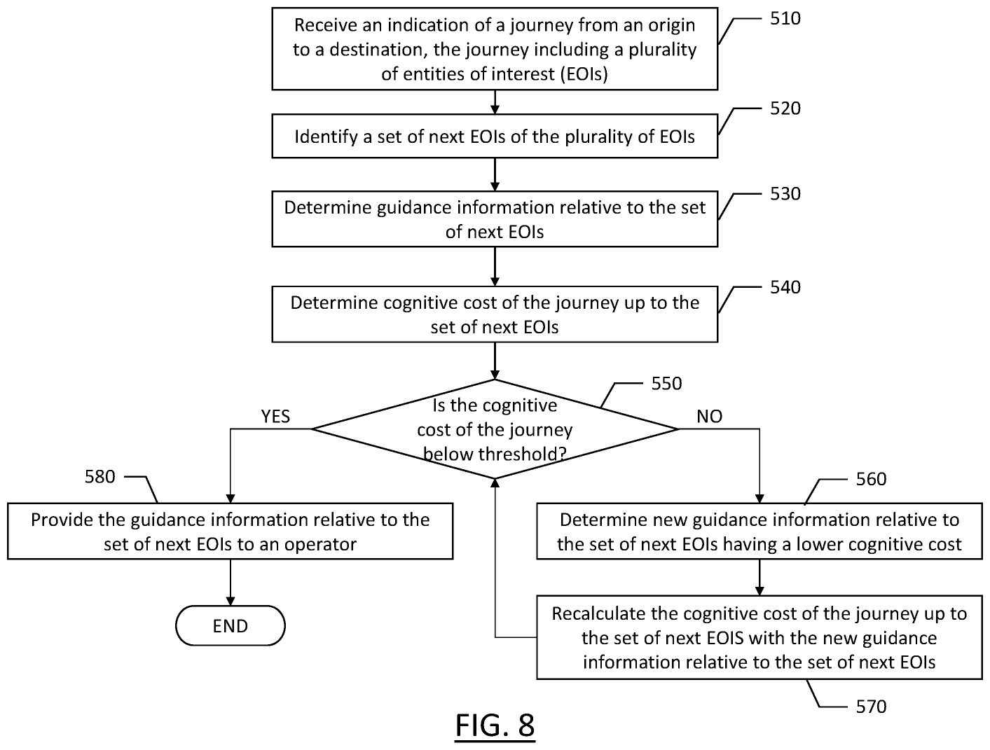

FIG. 8 is a flowchart illustrative of one or more methods according to example embodiments of the present disclosure. It will be understood that each block of the flowcharts and combination of blocks in the flowcharts may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above may be stored by a memory device 26 of an apparatus employing an embodiment of the present invention and executed by a processor 24 of the apparatus 20. As will be appreciated, any such computer program instructions may be loaded onto a computer or other programmable apparatus (for example, hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowcharts support combinations of means for performing the specified functions and combinations of operations for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

FIG. 8 illustrates a method determining a cognitive cost to an operator for a journey, and more particularly, to reducing the cognitive cost of a journey to an operator through a reduction in the cognitive cost of guidance information. As shown, an indication of a journey is received at 510 from an origin to a destination with the journey including a plurality of entities of interest (EOIs) along the journey. The journey of an example embodiment is a route from an origin to a destination with the EOIs being different maneuvers and/or points-of-interest along the route for which information may be provided to an operator of a vehicle traveling along the route. A set of next EOIS of the plurality of EOIs are identified at 520. This set of next EOIs can be a single point-of-interest or maneuver, or a combination of maneuvers and/or points-of-interest, for example. Guidance information is determined relative to the set of next EOIs at 530. For example, embodiments may determine guidance to be an instruction concerning a maneuver that is in the set of next EOIs. A cognitive cost of the journey up to the set of next EOIs is determined at 540. This determination considers the cognitive cost of the journey up to and including the set of next EOIs to determine if the cognitive load is too high.

With further reference to FIG. 8, at 550 it is determined if the cognitive cost of the journey is below a threshold. This determination is made to establish if the cognitive cost is overwhelming to an operator of a vehicle. If the cognitive cost of the journey fails to satisfy a predetermined value (e.g., is above a threshold value), new guidance information is determined relative to the set of next EOIs having a lower cognitive cost at 560. This can be performed, for example, by using a behavior and cognitive model as described above. With the new guidance information relative to the set of next EOIs, the cognitive cost of the journey up to the set of next EOIs is recalculated at 570. The process then determines again if the cognitive cost of the journey is below the threshold at 550. If the cognitive cost of the journey is below the threshold at 550, the process proceed with providing the guidance information relative to the set of next EOIs to an operator of a vehicle at 580. The iterative loop from decision block 550 may not be implemented if the cognitive cost of the journey determined at 540 is already below the threshold at 550.

In an example embodiment, an apparatus for performing the methods of FIG. 8 above may include a processor (e.g., the processor 24) configured to perform some or each of the operations (510-580) described above. The processor may, for example, be configured to perform the operations (510-580) by performing hardware implemented logical functions, executing stored instructions, or executing algorithms for performing each of the operations. Alternatively, the apparatus may comprise means for performing each of the operations described above. In this regard, according to an example embodiment, examples of means for performing operations 510-580 may comprise, for example, the processor 24 and/or a device or circuit for executing instructions or executing an algorithm for processing information as described above.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. An apparatus comprising at least one processor and at least one non-transitory memory including computer program code instructions, the computer program code instructions configured to, when executed, cause the apparatus to at least:
receive an indication of a journey from an origin to a destination, wherein the journey comprises a plurality of entities of interest (EOIs) along the journey;
identify a set of next EOIs of the plurality of EOIs;
determine guidance information relative to the set of next EOIs;
determine cognitive cost of the journey up to the set of next EOIs;
in response to the cognitive cost of the journey up to the set of next EOIs not satisfying a predetermined value:
determine new guidance information relative to the set of next EOIs having a lower cognitive cost;
recalculate the cognitive cost of the journey up to the set of next EOIs with the new guidance information relative to the set of next EOIs; and
in response to the cognitive cost of the journey up to the set of next EOIs satisfying the predetermined value, provide the guidance information relative to the set of next EOIs to an operator.

2. The apparatus of claim 1, causing the apparatus to identify the set of next EOIs of the plurality of EOIs comprises causing the apparatus to obtain a cognitive load for the set of next EOIs based on historical behavior models and obtain a current cognitive state of the operator.

3. The apparatus of claim 2, wherein causing the apparatus to determine cognitive cost of the journey up to the set of next EOI comprises causing the apparatus to:
determine the cognitive cost of the journey up to the set of next EOIs by inputting to a cognitive model the cognitive load for the set of next EOIs, the current cognitive state of the operator, and the guidance information.

4. The apparatus of claim 1, wherein causing the apparatus to determine guidance information relative to the set of next EOIs comprises causing the apparatus to:
identify gaps in understanding of information or maneuvers relative to the set of next EOIs; and
generate guidance information to fill identified gaps in understanding.

5. The apparatus of claim 1, wherein causing the apparatus to determine new guidance information relative to the set of next EOIs having a lower cognitive cost comprises causing the apparatus to:
determine the guidance information relative to the set of next EOIs having a lower cognitive cost using operator context, a behavior model, and a cognitive model.

6. The apparatus of claim 1, wherein causing the apparatus to determine cognitive cost of the journey up to the set of next EOIs comprises causing the apparatus to:
determine a cognitive cost for each of the plurality of EOIs up to and including the set of next EOIs, wherein the cognitive cost for each of the plurality of EOIs is determined based on a cognitive state of a respective EOI, a duration of the cognitive state of the respective EOI, and a weight afforded to the respective EOI.

7. The apparatus of claim 6, wherein the cognitive cost for each of the plurality of EOIs is further determined based on a cognitive state transition from a previous cognitive state to the cognitive state of the respective EOI and map information associated with the respective EOI.

8. A computer program product comprising at least one non-transitory computer-readable storage medium having computer-executable program code instructions stored therein, the computer-executable program code instructions comprising program code instructions to:
receive an indication of a journey from an origin to a destination, wherein the journey comprises a plurality of entities of interest (EOIs) along the journey;
determine guidance information relative to the plurality of EOIs along the journey;
determine a cognitive cost of the journey up to the destination based, at least in part, on the guidance information;
in response to the cognitive cost of the journey up to the destination failing to satisfy a predetermined value:
determine new guidance information relative to the destination having a lower cognitive cost;
determine a new cognitive cost for the journey up to the destination based, at least in part, on the new guidance information;
in response to the new cognitive cost of the journey up to the destination satisfying the predetermined value, provide the new guidance information relative to the destination; and
in response to the cognitive cost of the journey up to the destination satisfying the predetermined value, provide the guidance information relative to the destination.

9. The computer program product of claim 8, wherein the program code instructions to determine the cognitive cost of the journey up to the destination based, at least in part, on the guidance information further comprise program code instructions to determine the cognitive cost of the journey up to the destination based, at least in part, on the plurality of EOIs along the journey.

10. The computer program product of claim 9, wherein the program code instructions to determine the cognitive cost of the journey up to the destination based, at least in part, on the plurality of EOIs along the journey comprise program code instruction to obtain a cognitive load for each of the plurality of EOIs along the journey.

11. The computer program product of claim 10, wherein the program code instructions to determine the cognitive cost of the journey up to the destination based, at least in part, on the plurality of EOIs along the journey comprise program code instructions to determine the cognitive cost of the journey up to the destination by inputting to a cognitive model the cognitive load for each of the plurality of EOIs, a cognitive state of the operator, and the guidance information.

12. The computer program product of claim 8, wherein the program code instructions to determine guidance information relative to the destination comprises program code instructions to:
identify gaps in understanding of information or maneuvers relative to the plurality of EOIs; and
generate guidance information to fill identified gaps in understanding.

13. The computer program product of claim 8, wherein the program code instructions to determine new guidance information relative to the destination having a lower cognitive cost comprise program code instructions to:
determine the guidance information relative to the plurality of EOIs having a lower cognitive cost using operator context, a behavior model, and a cognitive model.

14. The computer program product of claim 8, wherein the program code instructions to determine a cognitive cost of the journey up to the destination based, at least in part, on the guidance information comprise program code instructions to:
determine a cognitive cost for each of the plurality of EOIs, wherein the cognitive cost for each of the plurality of EOIs is determined based on a cognitive state of a respective EOI, a duration of the cognitive state of the respective EOI, and a weight afforded to the respective EOI.

15. The computer program product of claim 14, wherein the cognitive cost for each of the plurality of EOIs is further determined based on a cognitive state transition from a previous cognitive state to the cognitive state of the respective EOI and map information associated with the respective EOI.

16. A method comprising:
receiving an indication of a journey from an origin to a destination, wherein the journey comprises a plurality of entities of interest (EOIs) along the journey;
identifying a next entity of interest (EOI) of the plurality of EOIs;
determining guidance information relative to the next EOI;
determining cognitive cost of the journey up to the next EOI;
in response to the cognitive cost of the journey up to the next EOI not satisfying a predetermined value:
determining new guidance information relative to the next EOI having a lower cognitive cost;
recalculating the cognitive cost of the journey up to the next EOI with the new guidance information relative to the EOI; and
in response to the cognitive cost of the journey up to the next EOI satisfying a predetermined value, providing the guidance information relative to the next EOI to an operator.

17. The method of claim 16, identifying the next EOI of the plurality of EOIs comprises obtaining a cognitive load for the next EOI based on historical behavior models and obtaining a current cognitive state of the operator.

18. The method of claim 17, wherein determining cognitive cost of the journey up to the next EOI comprises:
determining the cognitive cost of the journey up to the next EOI by inputting to a cognitive model the cognitive load for the next EOI, the current cognitive state of the operator, and the guidance information.

19. The method of claim 16, wherein determining guidance information relative to the next EOI comprises:
identifying gaps in understanding of information or maneuvers relative to the next EOI; and
generating guidance information to fill identified gaps in understanding.

20. The method of claim 16, wherein determining new guidance information relative to the next EOI having a lower cognitive cost comprises:
determining the guidance information relative to the next EOI having a lower cognitive cost using operator context, a behavior model, and a cognitive model.
